(19) United States
(12) Patent Application Publication
(10) Pub. No.: US 2016/0172883 A1
(43) Pub. Date: Jun. 16, 2016

(54) Electronics Case with Incorporated Connector

(71) Applicant: Rivo Case, LLC, Sunny Isles Beach, FL (US)

(72) Inventors: Jonathan Globerson, Sunny Isles Beach, FL (US); Alon Bluemenzwieg, Tel Aviv (IL); Ariel Peremen, Tel Aviv (IL)

(21) Appl. No.: 14/014,790

(22) Filed: Aug. 30, 2013

Related U.S. Application Data
(60) Provisional application No. 61/694,806, filed on Aug. 30, 2012.

(51) Int. Cl. H02J 7/00

(52) U.S. Cl. CPC H02J 7/0044

(57) ABSTRACT

An electronics case is configured with two charging configurations whereby either a flexible cable permanently attached to the case or a receiving port accessible from the exterior of the case are selectively used.

### INDEX TO RELATED APPLICATIONS

This application is a non-provisional of, and claims benefit to U.S. Provisional Patent Application Ser. No. 61/694,806 filed Aug. 30, 2012 the disclosure of which is incorporated herein by reference in its entirety.

### BACKGROUND OF THE INVENTION

The present invention relates to accessories for hand-held electronic devices, particularly a case for such devices. In one embodiment, the case of the invention relates to hand held cell phone case that reduces the risk of accidental damage due to physical trauma while allowing the case to connect directly to a power source for charging the cell phone.

Although there are many protective and charging cases, there are no known cases providing simultaneous protection to cell phones incorporating a resident cable thereon.

Thus, there is a need for an improved case for electronic devices such as a cell phone, tablet computers and the like, that provides protection for the device that also allows it to charge by connecting the case directly onto the power source such as a USB port and the like without removing the phone from the case or using assistance from cables and additional charging devices or accessories.

### SUMMARY OF THE INVENTION

In one embodiment, the present invention is a case for electronic devices comprising:

a lower body;

an upper body;

a first charging device being a cable having a first end permanently attached to said upper body and a second end with a charging plug incorporated thereon; and

a second charging device being a receiving port incorporated with said lower body, wherein said case is configured to charge an electronic device including a cell phone, tablet computer, or other electronic devices secured within said case by selectively utilizing either said cable or said receiving port.

The case lower body and upper body are constructed and arranged to connect one to another and form a single case. The upper body has a protective receiver configured to accept the second end of the cable.

In one embodiment, the protective receiver is configured to accept the second end of the cable and has a locking system for locking the second end into the protective receiver.

In one embodiment, there is an external indicator configured to visually display an amount of charge on a cell phone held within the case.

In one embodiment, the invention is a case for holding and charging an electronic device comprising:

a unitary body having a lower body region and an upper body region;

a first charging device being a cable having a first end permanently attached to said body and a second end with a charging plug incorporated thereon; and

a second charging device being a receiving port incorporated with said lower body region, wherein said case is configured to charge an electronic device secured within said case by selectively utilizing either said cable or said receiving port.

The unitary body has a protective receiver configured to accept said second end of said cable.

In one embodiment, the unitary body has a protective receiver configured to accept said second end of said cable and a locking system for locking the second end into the protective receiver.

In one embodiment, The case of claim 6 further including an external indicator configured to visually display an amount of charge on a cell phone held within the case.

### BRIEF DESCRIPTION OF THE SEVERAL VIEWS OF THE DRAWING

FIG. 1 is a front view of the case of the present invention.

FIG. 2 is a rear view of the case of the present invention.

FIG. 3 is a side view of the case of the present invention.

FIG. 4 is a side view of the case of the present invention.

FIG. 5 is a perspective view of the inside case of the present invention.

FIG. 6 is a perspective view of the outside of the case of the present invention.

FIG. 7 is a perspective view of the outside of the case of the present invention demonstrating a disengaged charging cable from its holder.

FIG. 8 is a perspective view of the inside of the case of the present invention demonstrating a disengaged charging cable from its holder.

FIG. 9 is a side partial cross-section view of the case the present invention

FIG. 10 is an expanded view of various components on the case of the present invention.

FIG. 11 is an expanded view of various components on the present invention.

FIG. 12 is a top view of the case of the present invention.

FIG. 13 is a bottom view of the case of the present invention.

FIG. 14 is a separated front perspective view of the case of the present invention.

FIG. 15 is a separated rear view of the case of the present invention.

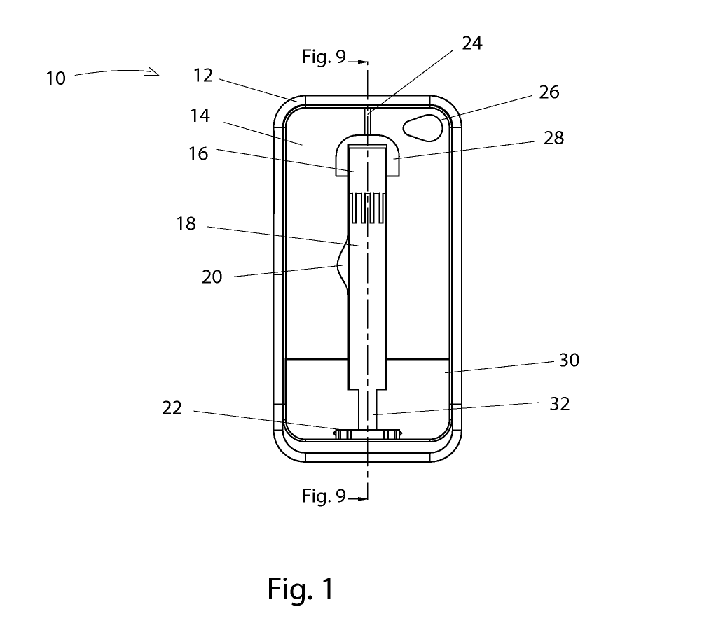

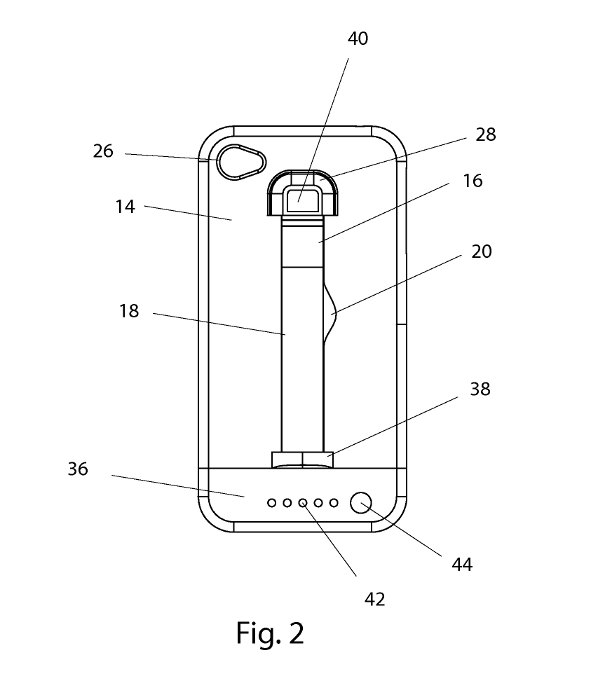

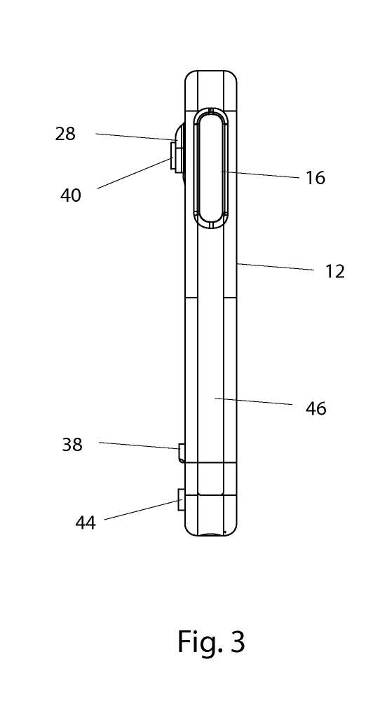

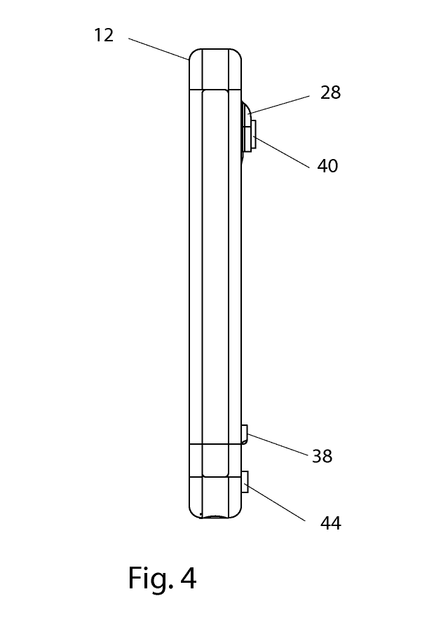

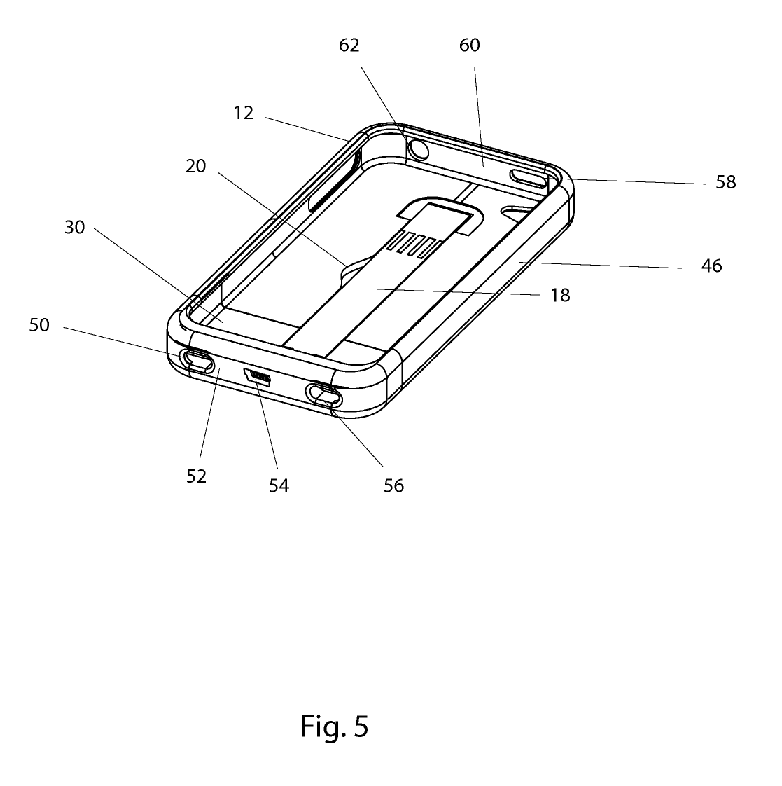

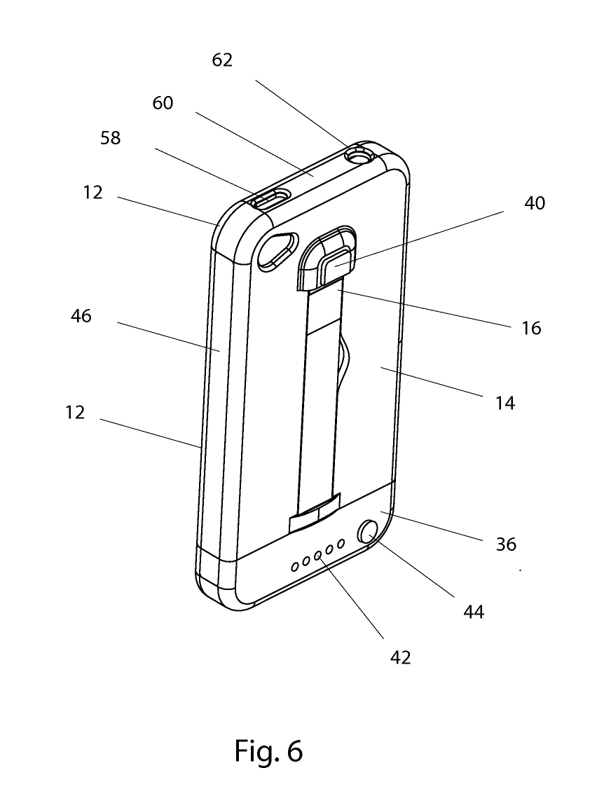

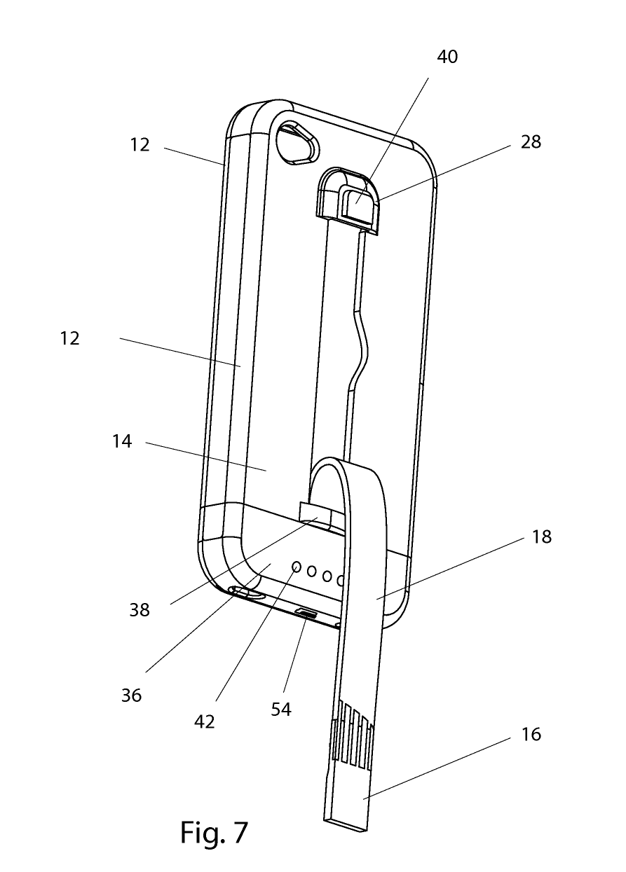

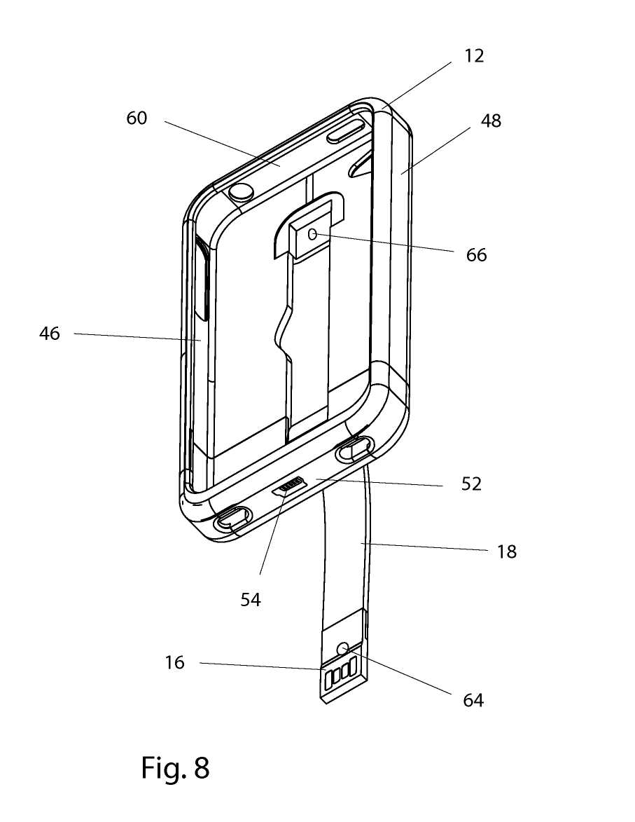

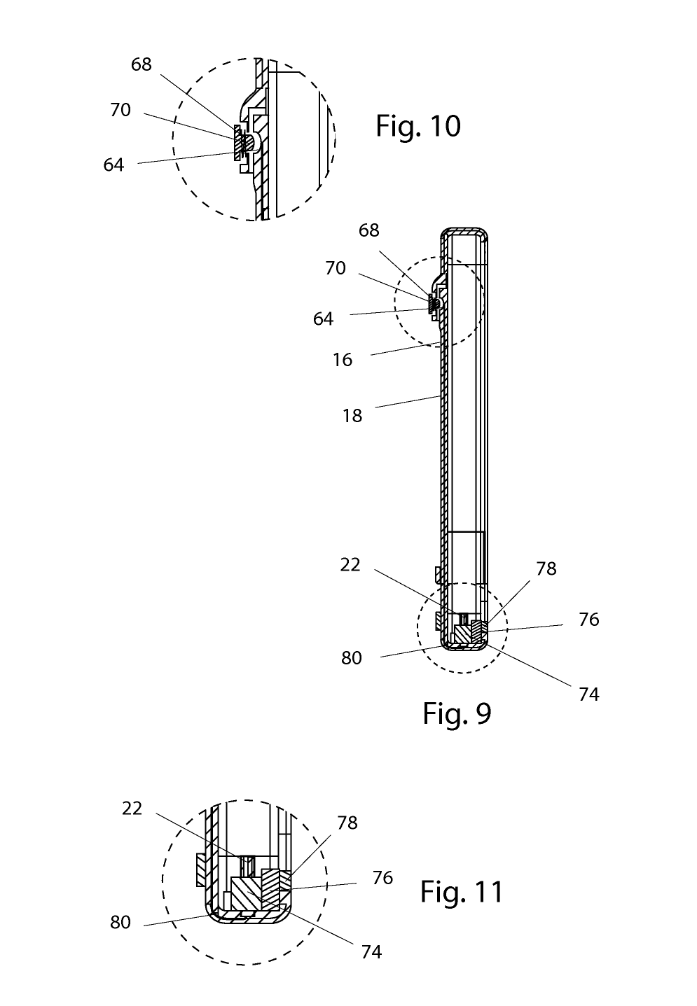

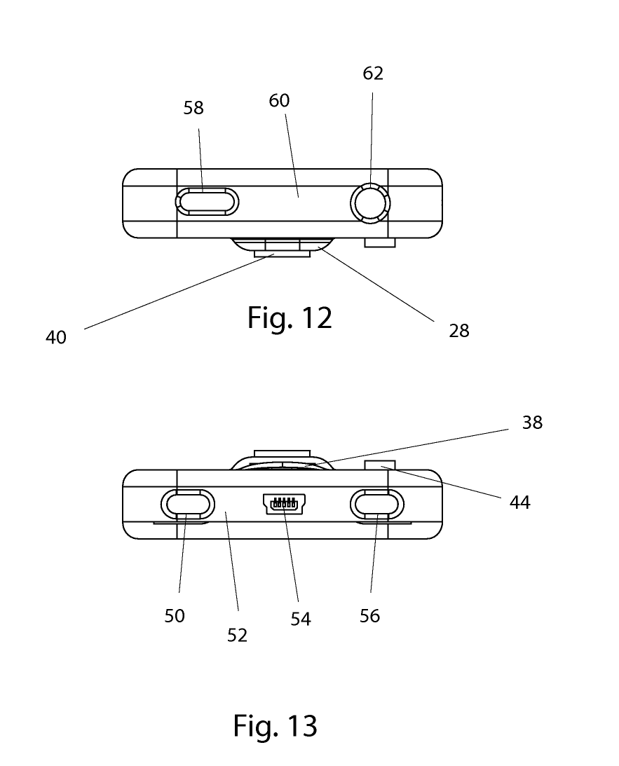

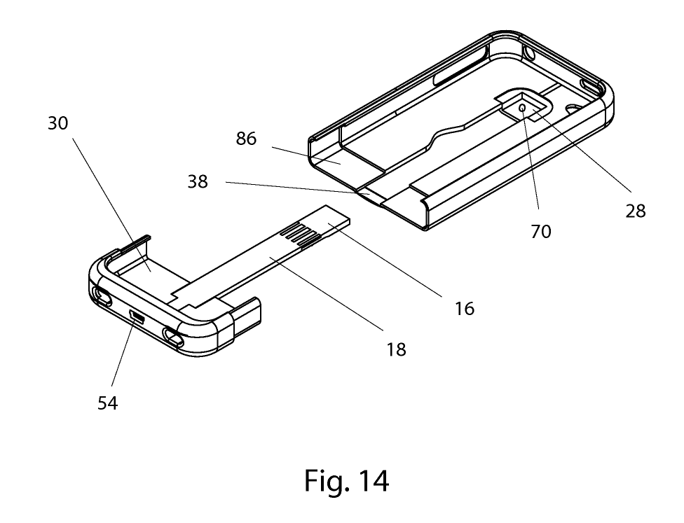

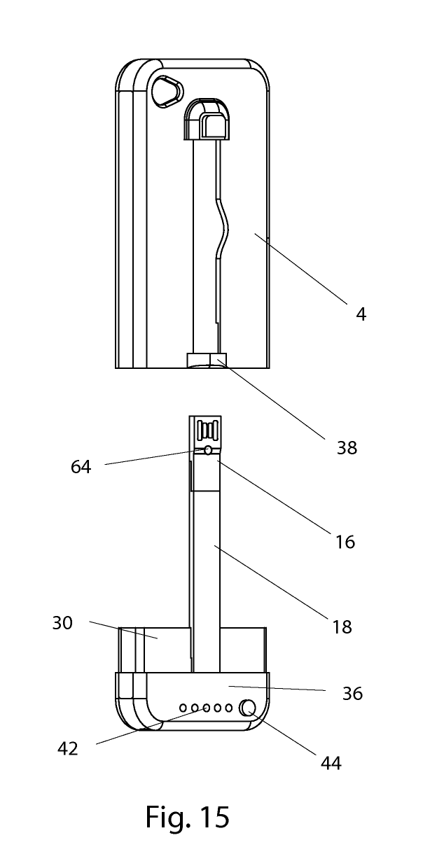

### DETAILED DESCRIPTION OF THE PREFERRED EMBODIMENT

The present invention relates to a case for an electronic device having improved characteristics and functionality. Case 10 has upper body 14 and is surrounded by protector 12 about its perimeter. Upper body 14 is constructed and arranged to mate with lower body 30. Upper body 14 includes a permanently attached mount 38 that secures a flexible cable 18 onto upper body 14. Flexible cable 18 is constructed and arranged to charge a phone (not shown) held within case 10. In one embodiment, flexible cable 18 has a USB connector incorporated thereon. In one embodiment, case 12 has incorporated on its rear section finger orifice 20 constructed and arranged such that a user can inserts their finger into the orifice, grasp flexible cable 18 and move it away from the surface of upper body 14. Upper body 14 has incorporated thereon protective receiver 28 constructed and arranged to receive and subsequently disengage flexible cable 18. In one embodiment, protective receiver 28 has incorporated thereon a spring loaded actuator 40 whereby said actuator, when engaged, holds flexible cable 18 into position with in protective receiver 28, and can be pressed in order to release the terminal end of flexible cable 18 in which a charging plug is incorporated thereon.

Case 10 is constructed and arranged and further can be customized to accommodate various features of cell phones, tablet computers, and similar devices. By way of example only, lower body 30 has a first speaker orifice 50 and or a second speak orifice 56. Lower body 30 is incorporated with a female entrance port 54 on lower body lower surface 52 that can be configured either as an electronic receiver or as an orifice providing access to the charging receiver of an electronic device, for example, a cell phone or tablet computer. Case 10 further can incorporate any one of headphone orifice 62 and locking access orifice 58 incorporated on the uppermost portion 60 of upper body 14 and camera orifice 28 on the planer surface of upper body 14.

In one embodiment, lower body 30 has an exterior surface 36 having a charge indicator button 44 and a plurality of charge indicator lights 42 incorporated thereon.

In one embodiment, USB connector 16 has notch 64 Incorporated there on whereby notched 64 interacts with locking pin 66. As generally understood, locking pin 66 is urged inward towards interior of case 10 by spring 78. Lock button 70 engages locking pin 66 into notch 64 and ultimately holds USB connector 16 into a fixed and locked position within protective receiver 28.

In one embodiment, lower body 30 has incorporated there in circuit board 76 that is configured to monitor charging and provide an information to indicator light 78 and/or lights 42. Lower body 30 can be constructed with a female receiving channel 80 constructed and arranged for mating upper body 14 with lower body 30.

In use, a cell phone, tablet computer or other electronic device is placed within the interior periphery of case 10 and the charging access port is connected to port 54 on lower body 30. A user will then select either access port 54 or cable 18 in order to charge the phone.

In one embodiment, when a user selects cable 18, it must be released from protective cover 28 into which it is locked. When a user is finished using cable 18, it is returned into protective cover 28 and locked into position.

Although the several figures are demonstrative of an embodiment with a configuration including a two piece case, it is further contemplated in the present invention that the case of the present invention can be configured as a single unitary piece. The single unitary piece will include two structures for charging a device placed therein. A first structure being a female receiving plug that is accessible from the exterior of the case and a second structure will be the flexible cable as described herein.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A case for holding and charging an electronic device comprising:
a lower body;
an upper body;
a first charging device being a cable having a first end permanently attached to said upper body and a second end with a charging plug incorporated thereon; and
a second charging device being a receiving port incorporated with said lower body, wherein said case is configured to charge an electronic device secured within said case by selectively utilizing either said cable or said receiving port.

2. The case of claim 1 wherein said lower body and upper body are constructed and arranged to connect one to another and form a single case.

3. The case of claim 1 wherein said upper body has a protective receiver configured to accept said second end of said cable.

4. The case of claim 1 wherein said upper body has a protective receiver configured to accept said second end of said cable and a locking system for locking the second end into the protective receiver.

5. The case of claim 1 further including an external indicator configured to visually display an amount of charge on an electronic device held within the case.

6. A case for holding and charging an electronic device comprising:
a unitary body having a lower body region and an upper body region;
a first charging device being a cable having a first end permanently attached to said body and a second end with a charging plug incorporated thereon; and
a second charging device being a receiving port incorporated with said lower body region, wherein said case is configured to charge an electronic device secured within said case by selectively utilizing either said cable or said receiving port.

7. The case of claim 6 wherein said unitary body has a protective receiver configured to accept said second end of said cable.

8. The case of claim 6 wherein said unitary body has a protective receiver configured to accept said second end of said cable and a locking system for locking the second end into the protective receiver.

9. The case of claim 6 further including an external indicator configured to visually display an amount of charge on an electronic device held within the case.
